(19) United States
(12) Patent Application Publication
(10) Pub. No.: US 2026/0186685 A1
(43) Pub. Date: Jul. 2, 2026

(54) INFORMATION PROCESSING SYSTEM, INFORMATION PROCESSING METHOD, AND COMPUTER READABLE STORAGE MEDIUM

(71) Applicants: SoftBank Corp., Tokyo (JP); AIZIP Inc., Cupertino, CA (US)

(72) Inventors: Yuko ISHIWAKA, Tokyo (JP); Minoru OWADA, Tokyo (JP); Kazuto SUDA, Tokyo (JP); Weier Wan, Cupertino, CA (US)

(21) Appl. No.: 19/001,598

(22) Filed: Dec. 26, 2024

(51) Int. Cl. G06F 3/06

(52) U.S. Cl. CPC G06F 3/0652; G06F 3/0608

(57) ABSTRACT

Provided is an information processing system including: a model provision unit which provides one or more models providing services to a user to a communication terminal of the user; a determination unit which determines whether or not the one or more models provided to the communication terminal by the model provision unit are to be adjusted, based on a change in at least either an amount of free space in a storage area of the communication terminal or utilization-related information related to utilization of the communication terminal by the user; and a model adjustment unit which adjusts the one or more models stored in the communication terminal, based on the amount of free space and the utilization-related information if the determination unit determines that the models are to be adjusted.

### BACKGROUND

### 1. Technical Field

The present invention relates to an information processing system, an information processing method, and a computer readable storage medium.

### 2. Related Art

Patent Document 1 describes a machine-learned model switching system.

### PRIOR ART DOCUMENTS

### Patent Document

Patent Document 1: International Publication No. 2019/193661

### BRIEF DESCRIPTION OF THE DRAWINGS

FIG. 1 schematically shows one example of an information processing system 10.

FIG. 2 schematically shows one example of a functional configuration of the information processing system 10.

FIG. 3 schematically shows one example of a hierarchical structure of a plurality of models 200.

FIG. 4 schematically shows one example of a general-purpose model 240.

FIG. 5 schematically shows one example of a model for specific domain 250.

FIG. 6 is an explanatory diagram for describing contents of processing in the information processing system 10.

FIG. 7 is an explanatory diagram for describing contents of processing in the information processing system 10.

FIG. 8 schematically shows examples of types of a model 200.

FIG. 9 is an explanatory diagram for describing contents of processing in the information processing system 10.

FIG. 10 schematically shows one example of a hardware configuration of a computer 1200 which functions as a server 100 or a communication terminal 300.

### DESCRIPTION OF EXEMPLARY EMBODIMENTS

Hereinafter, the present invention will be described through embodiments of the invention, but the following embodiments do not limit the invention according to claims. In addition, not all of the combinations of features described in the embodiments are essential to the solution of the invention.

For example, a scheme in which a large amount of on-site data is collected and processed using Artificial Intelligence (AI) on a server for smart aquafarming and fattening puts strain on data storage and a processing capacity. Accordingly, a possible approach would be to install a machine learning model on an edge device which collects the on-site data, conduct a simplified analysis by using an edge model, and further process only necessary data by using a model, which is on a server side, at a higher level. However, there is a problem that, when the machine learning model is installed on the edge device, there may not be sufficient capacities of a hard disk for storing the model and of a memory for running the model. Therefore, there is a challenge of constantly optimizing the machine learning model which is on an edge device side such that the model can provide a highly accurate output with a minimum capacity. Further, since a preference of a user and an amount of free space of the edge device change over time, there is a need to dynamically change the machine learning model installed on the edge device. This requires not only adding a function but also erasing a function which is no longer needed.

An information processing system 10 according to the present embodiment may be, for example, a system which automatically optimizes the machine learning model of the edge device in accordance with the preference of the user and the amount of free space of the edge device. As one specific example, an “optimizer” capable of collecting information on a capacity of the edge device and the preference of the user is provided for each edge device, and this optimizer decides whether or not to install a machine learning model with an optimal capacity and an optimal function on the edge device. At this time, since the optimizer operates on the edge device side, it cannot retain information on a higher-level model or management information on its optimized domain. Accordingly, the optimizer feeds back the capacity of the edge device and the preference of the user to one or more “domain dividers” on the server side to obtain advice on what kind of domain model is optimal. In consideration of that advice, the optimizer requests the server side to perform installation/uninstallation processing.

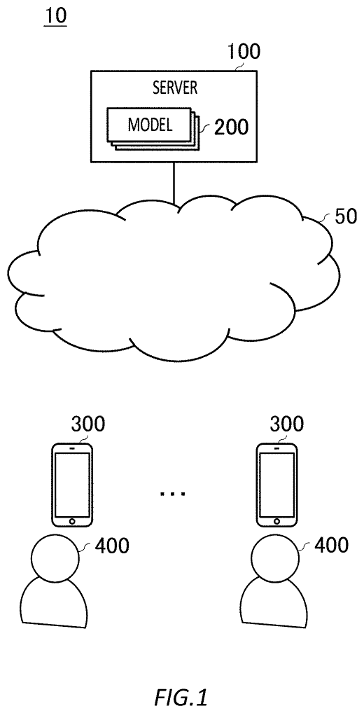

FIG. 1 schematically shows one example of an information processing system 10. The information processing system 10 includes a server 100. The information processing system 10 may include a communication terminal 300.

The server 100 and the communication terminal 300 may communicate via a network 50. The network 50 may include Internet. The network 50 may include a Local Area Network (LAN). The network 50 may include a mobile communication network. The mobile communication network may conform to any of the following communication methods: a Long Term Evolution (LTE) communication method, a 5th Generation (5G) communication method, a 3rd Generation (3G) communication method, or a 6th Generation (6G) or later communication method.

The server 100 stores a plurality of models 200 which provide services to a user 400 who is an operator of the communication terminal 300. The server 100 provides one or more models 200 to the communication terminal 300. The communication terminal 300 stores the one or more models 200 provided from the server 100, and provides services provided by the one or more models 200 to the user 400.

The model 200 is, for example, a learning model generated through machine learning. The learning model provides an output for an input based on learned knowledge.

The model 200 is, for example, a rule-based model which operates in accordance with a determined rule. For example, the rule-based model provides an output for an input in accordance with a rule. The rule-based model may be a so-called application.

The information processing system 10 according to the present embodiment adjusts the one or more models 200 stored in the communication terminal 300, in response to at least any of a change in an amount of free space in a storage area of the communication terminal 300, a change in a position of the communication terminal 300, a change in a purpose of the utilization of the communication terminal 300 by the user 400, a change in a preference of the user 400, or the like.

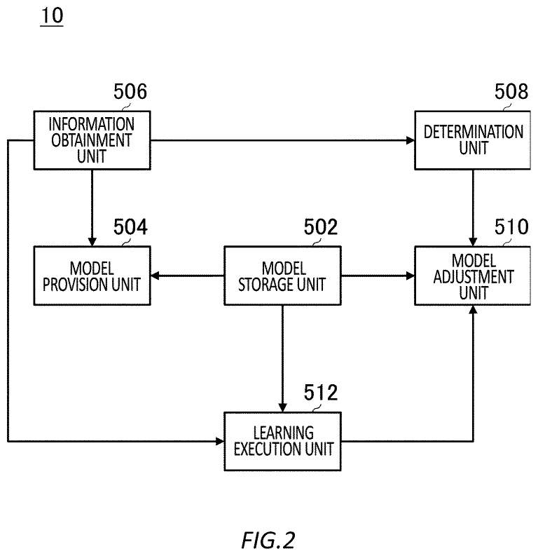

FIG. 2 schematically shows one example of a functional configuration of the information processing system 10. The information processing system 10 includes a model storage unit 502, a model provision unit 504, an information obtainment unit 506, a determination unit 508, a model adjustment unit 510, and a learning execution unit 512. It should be noted that it is not necessarily required for the information processing system 10 to include all of them.

The model storage unit 502 stores a plurality of models 200. The model storage unit 502 may be provided in the server 100.

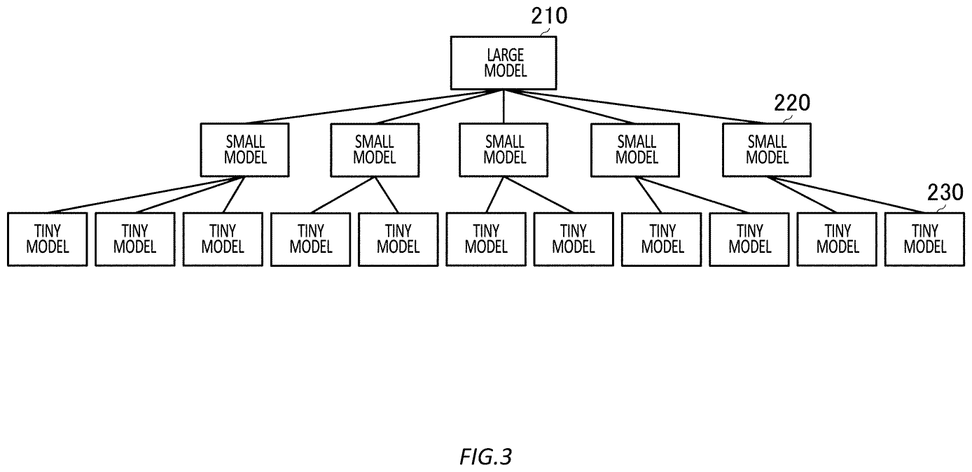

The plurality of models 200 stored in the model storage unit 502 may have a hierarchical structure. For example, the model storage unit 502 stores a large model 210, a plurality of small models 220 subordinate to the large model 210, and a plurality of tiny models 230 subordinate to each of the plurality of small models 220, as illustrated in FIG. 3. A small model 220 has a smaller amount of data than the large model 210, and a tiny model 230 has a smaller amount of data than the small model 220. The hierarchical structure which the plurality of models 200 stored in the model storage unit 502 have is not limited to a three-layered structure, and may be a two-layered structure, or may be a four or more-layered structure.

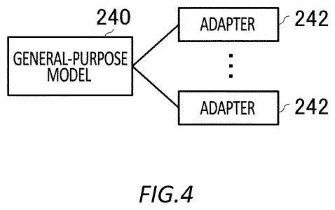

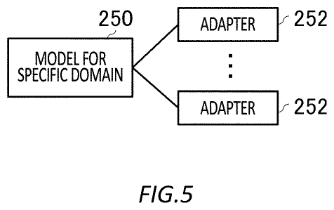

A plurality of models 200 may include a general-purpose model 240 trained with data on diverse domains, and a model for specific domain 250 trained with data on a specific domain, as illustrated in FIG. 4 and FIG. 5. For example, the model storage unit 502 stores a small general-purpose model trained with a large amount of data on diverse domains, and a tiny general-purpose model trained with a smaller amount of data than the amount of data with which the small general-purpose model is trained and having a smaller amount of data than the small general-purpose model. In addition, the model storage unit 502 stores a small specific-domain model trained with a large amount of data on a specific domain, and a tiny specific-domain model trained with a smaller amount of data than the amount of data with which the small specific-domain model is trained and having a smaller amount of data than the small specific-domain model. Examples of the specific domain may include mathematics, writing, coding, finance, Information Technology (IT), and the like, but are not limited thereto and may include any existing domain.

The model storage unit 502 may store an adapter 242 which can be applied to the general-purpose model 240. The model storage unit 502 may store a plurality of adapters 242. The adapter 242 may be like a patch in software, and may be data on a specific domain for tuning the general-purpose model 240. The adapter 242 can adapt the general-purpose model 240 to a specific domain while still maintaining general knowledge of the general-purpose model 240. An amount of data of the adapter 242 is small compared to an amount of data of the general-purpose model 240. The amount of data of the adapter 242 may be, for example, about one tenth or one hundredth of the amount of data of the general-purpose model 240. The adapter 242 can be dynamically applied to the general-purpose model 240 as needed, and the plurality of adapters 242 can be concurrently applied to the general-purpose model 240.

The model storage unit 502 may store an adapter 252 which can be applied to the model for specific domain 250. The model storage unit 502 may store a plurality of adapters 252. The adapter 252 may be like a patch in software, and may be data on a finer specific domain for tuning the model for specific domain 250. The adapter 252 can adapt the general-purpose model 240 to a finer specific domain while still maintaining knowledge on a specific domain of the model for specific domain 250. Specific examples of adapters which can be applied to a model for mathematics include a linear algebra adapter, a differential and integral calculus adapter, a statistics adapter, a geometry adapter, and the like. An amount of data of the adapter 252 is small compared to an amount of data of the model for specific domain 250. The amount of data of the adapter 252 may be, for example, about one tenth or one hundredth of the amount of data of the model for specific domain 250. The adapter 252 can be dynamically applied to the model for specific domain 250 as needed, and the plurality of adapters 252 can be concurrently applied to the model for specific domain 250.

The model provision unit 504 provides one or more models 200 of the plurality of models 200 stored in the model storage unit 502 to the communication terminal 300. The model provision unit 504 may be provided in the server 100. The model provision unit 504 may provide the one or more models 200 to the communication terminal 300 upon a request from the communication terminal 300. For example, the model provision unit 504 provides the one or more models 200 designated by the user 400 to the communication terminal 300.

The information obtainment unit 506 obtains various kinds of information. The information obtainment unit 506 may obtain information on the communication terminal 300. The information obtainment unit 506 may continuously obtain the information on the communication terminal 300. The information obtainment unit 506 may periodically obtain the information on the communication terminal 300. The information obtainment unit 506 may obtain the information on the communication terminal 300 each time the information on the communication terminal 300 changes. The information obtainment unit 506 may be provided in the server 100. The information obtainment unit 506 may receive the information on the communication terminal 300 from the communication terminal 300. The information obtainment unit 506 may be provided in the communication terminal 300. The information obtainment unit 506 collects the information on the communication terminal 300.

For example, the information obtainment unit 506 obtains information on an amount of free space in a storage capacity of the communication terminal 300. For example, the information obtainment unit 506 obtains utilization-related information related to the utilization of the communication terminal 300 by the user 400. The information obtainment unit 506 may obtain the utilization-related information by generating the utilization-related information from the information on the communication terminal 300.

The utilization-related information may include the purpose of the utilization of the communication terminal 300 by the user 400. Examples of the purpose of the utilization include work, a personal matter, and the like. The purpose of the utilization may be further subdivided, and may be divided into types of the work and types of the personal matter. The information obtainment unit 506 may determine the purpose of the utilization based on the position of the communication terminal 300. For example, if the position of the communication terminal 300 is a place where the user 400 works, the information obtainment unit 506 determines that the purpose of the utilization is work, and if the position of the communication terminal 300 is not a place where the user 400 works, the information obtainment unit 506 determines that the purpose of the utilization is a personal matter. The information obtainment unit 506 may determine the purpose of the utilization based on the position of the communication terminal 300 and time. For example, if the position of the communication terminal 300 is a place where the user 400 works, when it is a time period in which the user 400 works, the information obtainment unit 506 determines that the purpose of the utilization is work, and when it is a time period in which the user 400 does not work, such as during a break or after work, the information obtainment unit 506 determines that the purpose of the utilization is a personal matter. The information obtainment unit 506 may generate data indicating a correspondence, in a past, between the position of the communication terminal 300 and the purpose of the utilization, and use that data to determine the purpose of the utilization. The information obtainment unit 506 may generate data indicating a correspondence, in a past, between the position of the communication terminal 300 and the time, and the purpose of the utilization, and use that data to determine the purpose of the utilization. The information obtainment unit 506 may determine the purpose of the utilization based on a schedule of the user 400. For example, the information obtainment unit 506 determines the purpose of the utilization based on the schedule of the user 400 managed in the communication terminal 300 or on the schedule of the user 400 managed on a network. The purpose of the utilization may be inputted by the user 400.

The utilization-related information may include a history of the utilization of the communication terminal 300 by the user 400. Examples of the history of the utilization include the model 200 utilized in the communication terminal 300, a service such as a Web service utilized in the communication terminal 300, input contents inputted by the user 400 in the communication terminal 300, output contents outputted to the user 400 in the communication terminal 300, and the like.

The utilization-related information may include the preference of the user 400 specified based on the utilization of the communication terminal 300 by the user 400. The information obtainment unit 506 may specify the preference of the user 400 based on the model 200 utilized in the communication terminal 300 by the user 400, a service such as a Web service utilized in the communication terminal 300 by the user 400, input contents inputted by the user 400 in the communication terminal 300, and the like.

The model provision unit 504 may prepare the one or more models 200 to be provided to the communication terminal 300, based on the information obtained by the information obtainment unit 506. For example, the model provision unit 504 prepares the one or more models 200 to be provided to the communication terminal 300, by executing at least either selecting the one or more models 200 from the plurality of models 200 or adjusting any of the plurality of models 200 based on the amount of free space of the communication terminal 300 and the utilization-related information. As a specific example, the model provision unit 504 prepares the models 200 to be provided to the communication terminal 300 so as to provide the one or more models 200 suitable for the utilization-related information while satisfying a condition in which a total amount of data of the one or more models 200 to be provided is smaller than the amount of free space of the communication terminal 300 or a predetermined proportion in the amount of free space of the communication terminal 300. The one or more models 200 suitable for the utilization-related information may be the one or more models 200 suited to the purpose of the utilization of the communication terminal 300 by the user 400. The one or more models 200 suitable for the utilization-related information may be the one or more models 200 suited to the history of the utilization of the communication terminal 300 by the user 400. The one or more models 200 suitable for the utilization-related information may be the one or more models 200 suited to the preference of the user 400.

The determination unit 508 determines whether or not the one or more models 200 provided to the communication terminal 300 by the model provision unit 504 are to be adjusted, based on the information on the communication terminal 300 obtained by the information obtainment unit 506. For example, the determination unit 508 determines whether or not the one or more models 200 provided to the communication terminal 300 by the model provision unit 504 are to be adjusted, based on a change in at least either the amount of free space in the storage area of the communication terminal 300 or the utilization-related information. For example, the determination unit 508 determines that the one or more models 200 of the communication terminal 300 are to be adjusted, if an amount of the change in at least either the amount of free space or the utilization-related information is greater than a predetermined threshold value.

The determination unit 508 may determine whether or not the one or more models 200 provided to the communication terminal 300 by the model provision unit 504 are to be adjusted, based on a change in the position of the communication terminal 300. The determination unit 508 determines that the one or more models 200 provided to the communication terminal 300 by the model provision unit 504 are to be adjusted, if an amount of the change in the position of the communication terminal 300 is greater than a predetermined threshold value, for example. The determination unit 508 determines that the one or more models 200 provided to the communication terminal 300 by the model provision unit 504 are to be adjusted, if an attribute of a place where the communication terminal 300 is located changes, for example. The attribute of the place may be a place type such as a general place, a workplace, or a leisure facility, or may be a location division such as a municipality, a prefecture, or a country.

The determination unit 508 may determine whether or not the one or more models 200 provided to the communication terminal 300 by the model provision unit 504 are to be adjusted, based on a change in a situation of the user 400. The determination unit 508 determines that the one or more models 200 provided to the communication terminal 300 by the model provision unit 504 are to be adjusted, if the situation changes from a situation in which the user 400 is working to a situation in which the user 400 is not working or the situation changes from the situation in which the user 400 is not working to the situation in which the user 400 is working, for example. The determination unit 508 determines that the one or more models 200 provided to the communication terminal 300 by the model provision unit 504 are to be adjusted, if the situation changes from a situation in which the user 400 is healthy to a situation in which the user 400 is not healthy or the situation changes from the situation in which the user 400 is not healthy to the situation in which the user 400 is healthy, for example.

The determination unit 508 may be provided in the server 100. The determination unit 508 may be provided in the communication terminal 300.

The model adjustment unit 510 adjusts the one or more models 200 stored in the storage area of the communication terminal 300, based on the amount of free space in the storage area of the communication terminal 300 and on the utilization-related information if the determination unit 508 determines that the one or more models 200 provided to the communication terminal 300 by the model provision unit 504 are to be adjusted.

For example, the model adjustment unit 510 erases any of the plurality of models 200 stored in the communication terminal 300, based on the utilization-related information such that a total amount of data of the plurality of models 200 stored in the communication terminal 300 is reduced if the amount of free space in the storage area of the communication terminal 300 is reduced. For example, the model adjustment unit 510 erases the plurality of models 200 stored in the communication terminal 300, in an order suited to the purpose of the utilization of the communication terminal 300 by the user 400, in an order suited to the history of the utilization of the communication terminal 300 by the user 400, or in an order suited to the preference of the user 400, until the amount of free space in the storage area of the communication terminal 300 becomes larger than a predetermined capacity.

For example, the model adjustment unit 510 reduces a function of at least any model of the one or more models 200 stored in the communication terminal 300 to reduce an amount of data, based on the utilization-related information such that the total amount of data of the one or more models 200 stored in the communication terminal 300 is reduced if the amount of free space in the storage area of the communication terminal 300 is reduced. For example, the model adjustment unit 510 reduces the function for at least any of the model 200 less suited to the purpose of the utilization of the communication terminal 300 by the user 400, the model 200 less suited to the history of the utilization of the communication terminal 300 by the user 400, or the model 200 less suited to the preference of the user 400 among the plurality of models 200 stored in the communication terminal 300, until the amount of free space in the storage area of the communication terminal 300 becomes larger than the predetermined capacity. Reducing the function of the model 200 may be reducing the function by performing data processing on the model 200 stored in the storage area of the communication terminal 300. Reducing the function by performing the data processing on the model 200 may be, for example, cancelling application of an adapter applied to the model 200. Reducing the function of the model 200 may be exchanging the model 200 stored in the storage area of the communication terminal 300 for the model 200 with fewer functions.

For example, the model adjustment unit 510 subdivides at least any model 200 of the one or more models 200 to erase some of models obtained through subdivision, based on the utilization-related information such that the total amount of data of the one or more models 200 stored in the communication terminal 300 is reduced if the amount of free space in the storage area of the communication terminal 300 is reduced. For example, the model adjustment unit 510 subdivides the one or more models 200 of the plurality of models 200 stored in the communication terminal 300 to erase some of models obtained through subdivision, until the amount of free space in the storage area of the communication terminal 300 becomes larger than the predetermined capacity. The model adjustment unit 510 may increase a number of at least one model 200 to be subdivided, until the amount of free space in the storage area of the communication terminal 300 becomes larger than the predetermined capacity. The model adjustment unit 510 may increase a number of models, which have been obtained through subdivision, to be erased, until the amount of free space in the storage area of the communication terminal 300 becomes larger than the predetermined capacity. Subdividing the model 200 may be deleting a higher-level model 200 and replacing it with a lower-level model 200.

These make it possible to adjust the one or more models 200 which can be utilized by the communication terminal 300 to the one or more models 200 suited to the purpose of the utilization by the user 400 or the like, within a range of the amount of free space if the amount of free space in the storage area of the communication terminal 300 is reduced, and to contribute improved convenience for the user 400.

For example, the model adjustment unit 510 adds one or more models 200 based on the utilization-related information such that the total amount of data of the plurality of models 200 stored in the communication terminal 300 is increased if the amount of free space in the storage area of the communication terminal 300 is increased. For example, the model adjustment unit 510 adds the one or more models 200, in an order suited to the purpose of the utilization of the communication terminal 300 by the user 400, in an order suited to the history of the utilization of the communication terminal 300 by the user 400, or in an order suited to the preference of the user 400, until the amount of free space in the storage area of the communication terminal 300 reaches the predetermined capacity.

For example, the model adjustment unit 510 increases the function of at least any model of the one or more models 200 stored in the communication terminal 300 to increase an amount of data, based on the utilization-related information such that the total amount of data of the one or more models 200 stored in the communication terminal 300 is increased if the amount of free space in the storage area of the communication terminal 300 is increased. For example, the model adjustment unit 510 increases the function for at least any of the model 200 more suited to the purpose of the utilization of the communication terminal 300 by the user 400, the model 200 more suited to the history of the utilization of the communication terminal 300 by the user 400, or the model 200 more suited to the preference of the user 400 among the plurality of models 200 stored in the communication terminal 300, until the amount of free space in the storage area of the communication terminal 300 reaches the predetermined capacity. Increasing the function of the model 200 may be increasing the function by performing the data processing on the model 200 stored in the storage area of the communication terminal 300, or may be exchanging the model 200 stored in the storage area of the communication terminal 300 for the model 200 with more functions. Performing the data processing on the model 200 may be applying an adapter to the model 200.

For example, the model adjustment unit 510 replaces at least any model 200 of the one or more models 200 with the higher-level model 200, based on the utilization-related information such that the total amount of data of the one or more models 200 stored in the communication terminal 300 is increased if the amount of free space in the storage area of the communication terminal 300 is increased. For example, the model adjustment unit 510 replaces, with the higher-level model 200, at least any of the model 200 more suited to the purpose of the utilization of the communication terminal 300 by the user 400, the model 200 more suited to the history of the utilization of the communication terminal 300 by the user 400, or the model 200 more suited to the preference of the user 400 among the one or more models 200 of the plurality of models 200 stored in the communication terminal 300, until the amount of free space in the storage area of the communication terminal 300 reaches the predetermined capacity.

These make it possible to enhance the one or more models 200 which can be utilized by the communication terminal 300, within the range of the amount of free space if the amount of free space in the storage area of the communication terminal 300 is increased, and to contribute the improved convenience for the user 400.

For example, the model adjustment unit 510 adjusts at least any of the one or more models 200 stored in the communication terminal 300, such that the one or more models 200 stored in the communication terminal 300 are more adapted to the utilization-related information which has been changed, if an amount of a change in the utilization-related information is greater than a predetermined threshold value. For example, the model adjustment unit 510 exchanges at least any of the one or more models 200 stored in the communication terminal 300 for another model 200 or performs data processing on at least any of the one or more models 200 stored in the communication terminal 300, such that the one or more models 200 stored in the communication terminal 300 are more adapted to the utilization-related information which has been changed, within a range in which the amount of free space in the storage area of the communication terminal 300 does not exceed the predetermined capacity.

For example, the model adjustment unit 510 erases at least any of the one or more models 200 stored in the communication terminal 300, such that the one or more models 200 stored in the communication terminal 300 are more adapted to the utilization-related information which has been changed, if the amount of the change in the utilization-related information is greater than the predetermined threshold value. For example, the model adjustment unit 510 erases at least any of the model 200 less suited to the purpose of the utilization of the communication terminal 300 by the user 400, the model 200 less suited to the history of the utilization of the communication terminal 300 by the user 400, or the model 200 less suited to the preference of the user 400 among the plurality of models 200 stored in the communication terminal 300.

These make it possible to make the one or more models 200 which can be utilized by the communication terminal 300 suitable for the preference, which has been changed, of the user 400, within the range of the amount of free space of the communication terminal 300 if the preference of the user 400 or the like changes, and to contribute the improved convenience for the user 400.

The model adjustment unit 510 may adjust the one or more models 200 stored in the communication terminal 300, based on the position of the communication terminal 300. The model adjustment unit 510 may increase the function of the model 200 suitable for the position of the communication terminal 300 among the one or more models 200 stored in the communication terminal 300, apply an adapter such that any of the one or more models 200 stored in the communication terminal 300 is suitable for the position of the communication terminal 300, or exchange the model 200 which is not suitable for the position of the communication terminal 300 among the one or more models 200 stored in the communication terminal 300, for the model 200 suitable for the position of the communication terminal 300.

The model adjustment unit 510 may adjust the one or more models 200 stored in the communication terminal 300, based on the situation of the user 400. The model adjustment unit 510 may increase the function of the model 200 suitable for the situation of the user 400 among the one or more models 200 stored in the communication terminal 300, apply an adapter such that any of the one or more models 200 stored in the communication terminal 300 is suitable for the situation of the user 400, or exchange the model 200 which is not suitable for the situation of the user 400 among the one or more models 200 stored in the communication terminal 300, for the model 200 suitable for the situation of the user 400.

The learning execution unit 512 executes various kinds of learning. For example, if the model adjustment unit 510 adjusts the one or more models 200 stored in the communication terminal 300, based on the amount of free space of the communication terminal 300 and the utilization-related information, the information obtainment unit 506 obtains evaluation of that adjustment by the user 400. The learning execution unit 512 executes learning about the adjustment, which is made based on the amount of free space of the communication terminal 300 and the utilization-related information, of the one or more models 200 stored in the communication terminal 300, such that adjustment of the plurality of models 200 for the amount of free space of the communication terminal 300 and the utilization-related information increases the evaluation by the user 400, based on multiple evaluations obtained by the information obtainment unit 506. The model adjustment unit 510 may use a result of the learning executed by the learning execution unit 512 to determine contents of the adjustment of the one or more models 200 stored in the communication terminal 300, from the amount of free space of the communication terminal 300 and the utilization-related information.

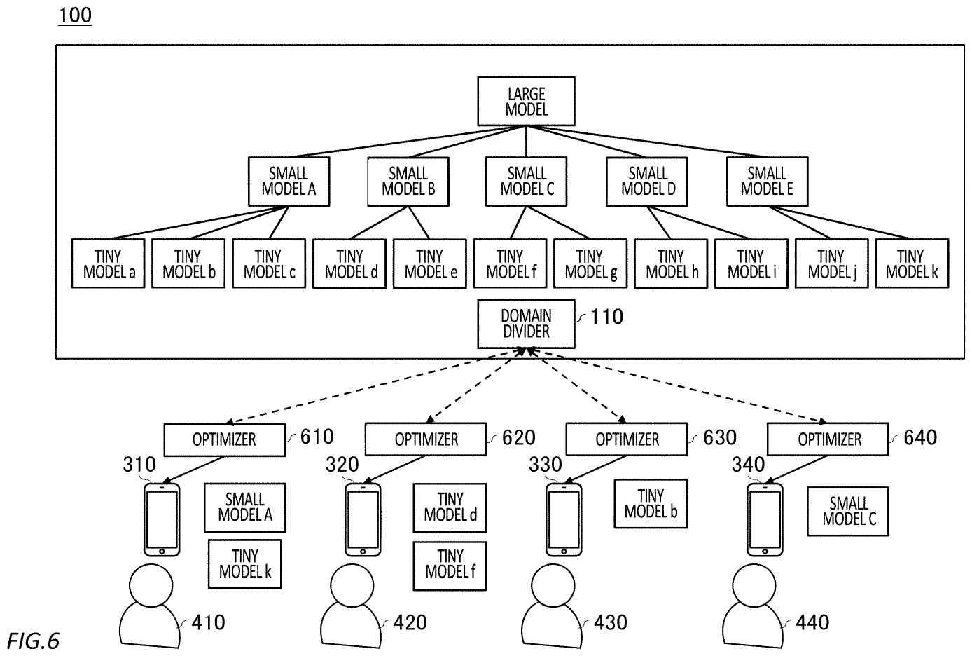

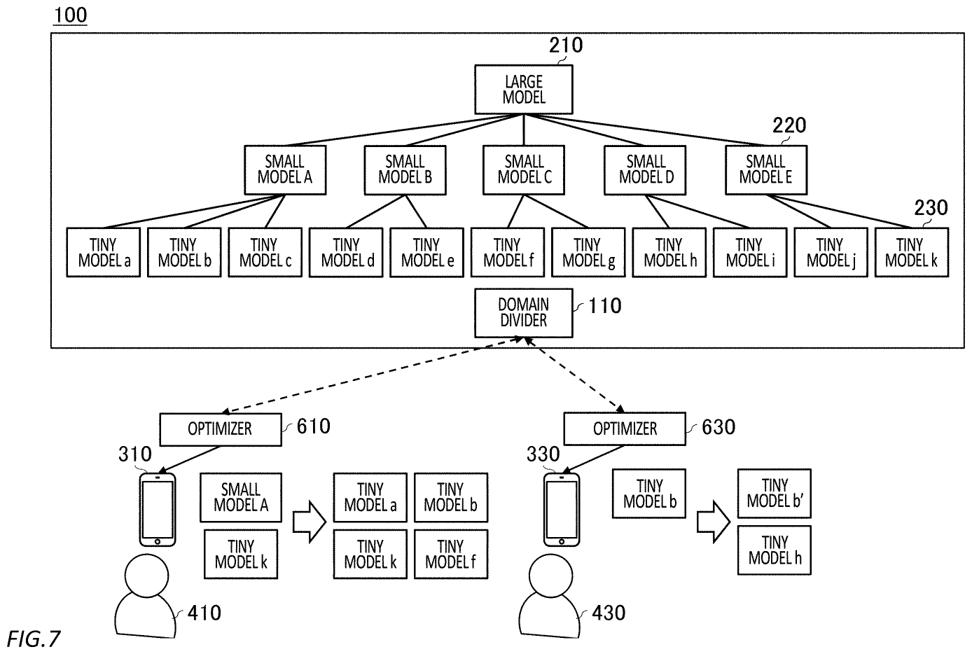

FIG. 6 and FIG. 7 are explanatory diagrams for describing contents of processing in the information processing system 10. In the examples shown in FIG. 6 and FIG. 7, the information processing system 10 includes a domain divider 110 provided in the server 100, and a plurality of optimizers 600 respectively corresponding to a plurality of communication terminals 300. An optimizer 600 may be provided in the communication terminal 300. The optimizer 600 may be provided in an apparatus different from the communication terminal 300. For example, the optimizer 600 is provided in an apparatus located between the server 100 and the communication terminal 300. Here, the domain divider 110 is described as including the model provision unit 504 and the model adjustment unit 510, and the optimizer 600 is described as including the information obtainment unit 506 and the determination unit 508, but they are not limited thereto.

FIG. 6 and FIG. 7 illustrate four optimizers 600 (an optimizer 610, an optimizer 620, an optimizer 630, an optimizer 640), four communication terminals 300 (a communication terminal 310, a communication terminal 320, a communication terminal 330, a communication terminal 340), and four users 400 (a user 410, a user 420, a user 430, a user 440). In addition, a small model A, a small model B, a small model C, a small model D, and a small model E are illustrated as examples of a plurality of small models 220. In addition, a tiny model a, a tiny model b, and a tiny model c are illustrated as examples of tiny models 230 subordinate to the small model A. In addition, a tiny model d and a tiny model e are illustrated as examples of tiny models 230 subordinate to the small model B. In addition, a tiny model f and a tiny model g are illustrated as examples of tiny models 230 subordinate to the small model C. In addition, a tiny model h and a tiny model i are illustrated as examples of tiny models 230 subordinate to the small model D. In addition, a tiny model j and a tiny model k are illustrated as examples of tiny models 230 subordinate to the small model E.

In the example shown in FIG. 6, the model provision unit 504 of the domain divider 110 provides the model 200 to each of the plurality of communication terminals 300 based on an amount of free space in the storage area of the communication terminal 300 and on utilization-related information. The small model A and the tiny model k are provided to the communication terminal 310. The tiny model d and the tiny model f are provided to the communication terminal 320. The tiny model b is provided to the communication terminal 330. The small model C is provided to the communication terminal 340.

In FIG. 7, the determination unit 508 of the optimizer 610 transmits a request for adjustment of the model 200 to the domain divider 110 in response to a decrease in a storage capacity of the communication terminal 310. The model adjustment unit 510 of the domain divider 110 executes adjustment of one or more models 200 of the communication terminal 310 upon the request for the adjustment.

The model adjustment unit 510 may cause any of a plurality of models 200 of the communication terminal 310 to be divided into fine models 200, and cause any of the fine models 200 obtained through division, to be erased. In addition, the model adjustment unit 510 may cause another model 200 to be installed in the communication terminal 310 in order to compensate for the erased model 200. In the example shown in FIG. 7, the model adjustment unit 510 causes the optimizer 610 to divide the small model A into the tiny model a, the tiny model b, and the tiny model c, to erase the tiny model c, and to add the tiny model f.

The model adjustment unit 510 may cause the communication terminal 310 to erase any of the plurality of models 200 and to install one or more models 200 subordinate to the erased model 200 in the communication terminal 310. In the example shown in FIG. 7, the model adjustment unit 510 causes the optimizer 610 to erase the small model A and to install the tiny model a, the tiny model b, and the tiny model f.

In addition, in FIG. 7, the determination unit 508 of the optimizer 630 transmits the request for the adjustment of the model 200 to the domain divider 110 in response to a change in a purpose of utilization of the communication terminal 330 by the user 430. The model adjustment unit 510 of the domain divider 110 executes the adjustment of the one or more models 200 of the communication terminal 310 upon the request for the adjustment.

The model adjustment unit 510 may adjust the model 200 of the communication terminal 330 to be suitable for the purpose of the utilization which has been changed. In the example shown in FIG. 7, the model adjustment unit 510 causes the optimizer 630 to change the tiny model b of the communication terminal 330 to a tiny model b′ suitable for the purpose of the utilization which has been changed, and to install the tiny model h capable of supporting the purpose of the utilization which has been changed.

The model adjustment unit 510 may cause the model 200 of the communication terminal 330 to be erased, and cause one or more models 200 suitable for the purpose of the utilization which has been changed, to be installed in the communication terminal 330. In the example shown in FIG. 7, the model adjustment unit 510 causes the optimizer 630 to erase the tiny model b and to install the tiny model b′ and the tiny model h. A change from the tiny model b to the tiny model b′ may be realized through application of an adapter, for example.

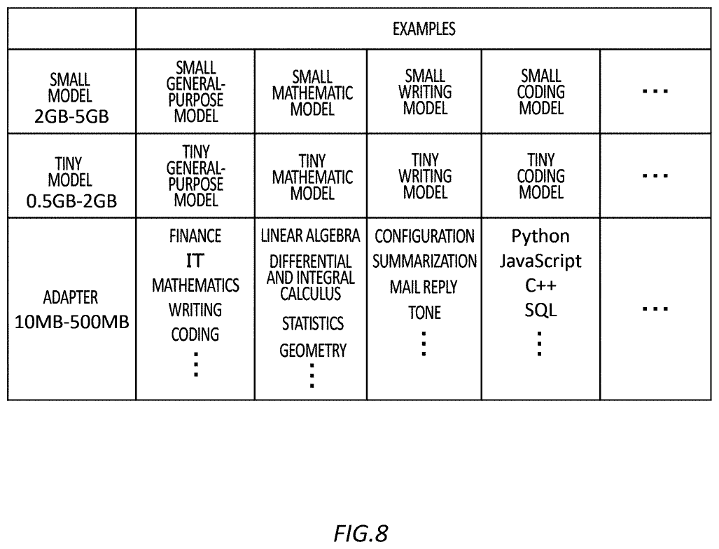

FIG. 8 schematically shows examples of types of the model 200 and types of an adapter. In the example shown in FIG. 8, an amount of data of the small model 220 is 2 GB to 5 GB, an amount of data of the tiny model 230 is 0.5 GB to 2 GB, and an amount of data of the adapter is 10 MB to 500 MB.

In addition, shown as examples of the small model 220 are a small general-purpose model trained with data on diverse domains, a small mathematic model trained with mathematics-related data, a small writing model trained with writing-related data, and a small coding model trained with coding-related data.

In addition, shown as examples of the tiny model 230 are a tiny general-purpose model having a smaller amount of data than the small general-purpose model, a tiny mathematic model having a smaller amount of data than the small mathematic model, a tiny writing model having a smaller amount of data than the small writing model, and a tiny coding model having a smaller amount of data than the small coding model.

In addition, shown as examples of the adapter for the small general-purpose model and the tiny general-purpose model are a finance adapter, an IT adapter, a mathematic adapter, a writing adapter, and a coding adapter. Shown as examples of the adapter for the small mathematic model and the tiny mathematic model are a linear algebra adapter, a differential and integral calculus adapter, a statistics adapter, and a geometry adapter. Shown as examples of the adapter for the small writing model and the tiny writing model are a configuration adapter, a summarization adapter, a mail reply adapter, and a tone adapter. Shown as examples of the adapter for the small coding model and the tiny coding model are a PYTHON (registered trademark) adapter, a JAVASCRIPT (registered trademark) adapter, a C++ adapter, and a Structured Query Language (SQL) adapter.

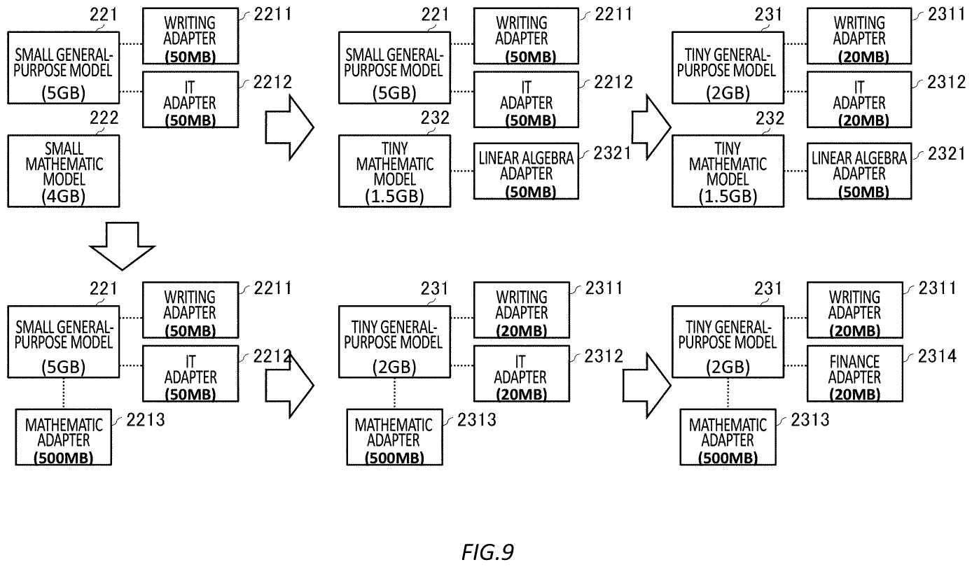

FIG. 9 is an explanatory diagram for describing contents of processing in the information processing system 10. Here, an example of adjustment by the model adjustment unit 510 will be described with a state, as a starting state, in which the information processing system 10 includes the plurality of models 200 illustrated in FIG. 8 and in which the domain divider 110 has provided, to a certain communication terminal 300, a small general-purpose model 221 of 5 GB to which a writing adapter 2211 of 50 MB and an IT adapter 2212 of 50 MB have been applied, and a small mathematic model 222 of 4 GB.

In a situation where the user 400 is using the communication terminal 300 to perform a mathematics-related task while asking a general question, if the amount of free space in the storage area of the communication terminal 300 is decreased and if most of contents of the mathematics-related task become linear algebra, the model adjustment unit 510 causes the optimizer 600 to erase the small mathematic model 222 of the communication terminal 300 and to install a tiny mathematic model 232 of 1.5 GB to which a linear algebra adapter 2321 of 50 MB has been applied. In this manner, if the purpose of the utilization of the communication terminal 300 by the user 400 narrows, the model adjustment unit 510 may cause the communication terminal 300 to erase the model 200 and to install the model 200 specialized for a narrowed purpose. This makes it possible to increase the amount of free space in the storage capacity of the communication terminal 300 without disturbing a task performed by the user 400.

Then, further, if the amount of free space in the storage area of the communication terminal 300 is decreased and if a number of at least one general question asked by the user 400 is reduced or contents of the question become simple, the model adjustment unit 510 causes the optimizer 600 to erase the small general-purpose model 221 of the communication terminal 300 and to install a tiny general-purpose model 231 to which a writing adapter 2311 and an IT adapter 2312 have been applied. In this manner, if a frequency of utilization of a certain function by the user 400 is reduced, the model adjustment unit 510 may cause the model 200 corresponding to that function to be erased, and cause the model 200 having a smaller amount of data to be installed. This makes it possible to increase the amount of free space in the storage capacity of the communication terminal 300 without disturbing the task performed by the user 400.

In a situation where the user 400 is using the communication terminal 300 to perform a mathematics-related task while asking a general question, if the amount of free space in the storage area of the communication terminal 300 is decreased and if a frequency of utilization of the small mathematic model 222 is no more as high as a frequency of utilization of the small general-purpose model 221, the model adjustment unit 510 causes the optimizer 600 to erase the small mathematic model 222 of the communication terminal 300 and to further apply a mathematic adapter 2213 of 500 MB to the small general-purpose model 221. In this manner, if a frequency of utilization of any model 200 of the plurality of models 200 stored in the communication terminal 300 is decreased, the model adjustment unit 510 may cause that any model 200 to be erased, and cause the model 200 having a smaller amount of data than that any model 200 to be installed. This makes it possible to increase the amount of free space in the storage capacity of the communication terminal 300 while maintaining a minimum function for mathematics.

Then, further, if the amount of free space in the storage area of the communication terminal 300 is decreased, the model adjustment unit 510 causes the optimizer 600 to erase the small general-purpose model 221 of the communication terminal 300 and to install the tiny general-purpose model 231 to which the writing adapter 2311, the IT adapter 2312, and a mathematic adapter 2313 have been applied. This makes it possible to increase the amount of free space in the storage capacity of the communication terminal 300 despite of slightly decreasing ability to answer a general question.

Further, if contents of the general question asked by the user 400 do not include an IP-related question and a number of at least one finance-related question starts to be increased, the model adjustment unit 510 causes the optimizer 600 to cancel and erase application of the IT adapter 2312 to the tiny general-purpose model 231 of the communication terminal 300 and to apply a finance adapter 2314 of 20 MB to the tiny general-purpose model 231. In this manner, if the purpose of the utilization of the communication terminal 300 by the user 400 changes, the model adjustment unit 510 may cancel application of an adapter corresponding to an excluded purpose or apply an adapter corresponding to an added purpose. This makes it possible to appropriately adjust the model 200 in response to a change in the purpose of the utilization of the communication terminal 300 by the user 400.

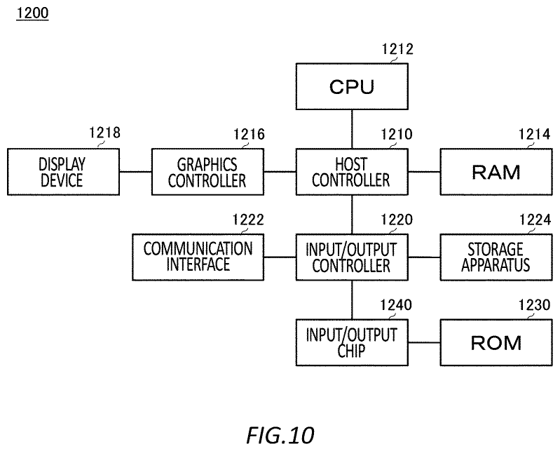

FIG. 10 schematically shows one example of a hardware configuration of a computer 1200 which functions as the server 100 or the communication terminal 300. Programs installed on the computer 1200 can cause the computer 1200 to function as one or more “units” of the apparatus according to the present embodiment described above or can cause the computer 1200 to execute operations associated with the apparatuses according to the present embodiment or the one or more “units”, and/or can cause the computer 1200 to execute a process according to the present embodiment or stages of the process. Such a program may be executed by a CPU 1212 to cause the computer 1200 to execute specific operations associated with some or all of the blocks in the flowcharts and block diagrams described in the present specification.

The computer 1200 according to the present embodiment includes the CPU 1212, a RAM 1214, and a graphics controller 1216, which are connected to each other via a host controller 1210. The computer 1200 also includes input/output units such as a communication interface 1222, a storage apparatus 1224, a DVD drive and an IC card drive, which are connected to the host controller 1210 via an input/output controller 1220. The DVD drive may be a DVD-ROM drive, a DVD-RAM drive, and the like. The storage apparatus 1224 may be a hard disk drive, a solid-state drive, and the like. The computer 1200 also includes legacy input/output units such as a ROM 1230 and a keyboard, which are connected to the input/output controller 1220 via an input/output chip 1240.

The CPU 1212 operates in accordance with the programs stored in the ROM 1230 and the RAM 1214, thereby controlling each unit. The graphics controller 1216 obtains image data which is generated by the CPU 1212 in a frame buffer or the like provided in the RAM 1214 or in itself so as to cause the image data to be displayed on a display device 1218.

The communication interface 1222 communicates with another electronic device via a network. The storage apparatus 1224 stores a program and data used by the CPU 1212 in the computer 1200. The DVD drive reads the programs or the data from the DVD-ROM or the like, and provides the storage apparatus 1224 with the programs or the data. The IC card drive reads the program and data from an IC card, and/or writes the program and data to the IC card.

The ROM 1230 stores therein a boot program or the like executed by the computer 1200 at the time of activation, and/or a program depending on the hardware of the computer 1200. The input/output chip 1240 may also connect various input/output units via a USB port, a parallel port, a serial port, a keyboard port, a mouse port, or the like to the input/output controller 1220.

A program is provided by a computer readable storage medium such as a DVD-ROM or an IC card. The program is read from the computer readable storage medium, installed into the storage apparatus 1224, the RAM 1214, or the ROM 1230, which are also examples of a computer readable storage medium, and executed by the CPU 1212. Information processing described in these programs is read by the computer 1200, and provides cooperation between the programs and the various types of hardware resources described above. An apparatus or method may be configured by achieving the operation or processing of information in accordance with the usage of the computer 1200.

For example, in a case where a communication is executed between the computer 1200 and an external device, the CPU 1212 may execute a communication program loaded in the RAM 1214 and instruct the communication interface 1222 to execute communication processing based on a process described in the communication program. The communication interface 1222, under control of the CPU 1212, reads transmission data stored on a transmission buffer region provided in a recording medium such as the RAM 1214, the storage apparatus 1224, the DVD-ROM, or the IC card, and transmits the read transmission data to a network or writes reception data received from a network to a reception buffer region or the like provided on the recording medium.

In addition, the CPU 1212 may cause all or a necessary portion of a file or a database, which has been stored in an external recording medium such as the storage apparatus 1224, the DVD drive (DVD-ROM), the IC card and the like, to be read into the RAM 1214, thereby executing various types of processing on the data on the RAM 1214. Next, the CPU 1212 may write the processed data back in the external recording medium.

A various types of information, such as various types of programs, data, tables, and databases, may be stored in the recording medium to undergo information processing. The CPU 1212 may execute, on the data read from the RAM 1214, various types of processing including various types of operations, information processing, conditional judgement, conditional branching, unconditional branching, information search/replacement, or the like described throughout the present disclosure and designated by instruction sequences of the programs, to write the results back to the RAM 1214. In addition, the CPU 1212 may search for information in a file, a database, or the like in the recording medium. For example, when a plurality of entries, each having an attribute value of a first attribute associated with an attribute value of a second attribute, are stored in the recording medium, the CPU 1212 may search for an entry whose attribute value of the first attribute matches a designated condition, from among the plurality of entries, and read the attribute value of the second attribute stored in the entry, thereby obtaining the attribute value of the second attribute associated with the first attribute that satisfies a predetermined condition.

The programs or software module described above may be stored on the computer 1200 or in a computer readable storage medium near the computer 1200. In addition, a recording medium such as a hard disk or a RAM provided in a server system connected to a dedicated communication network or the Internet can be used as the computer readable storage medium, thereby providing the program to the computer 1200 via the network.

Blocks in flowcharts and block diagrams in the present embodiments may represent stages of processes in which operations are executed or “units” of apparatuses responsible for executing operations. A specific stage and “unit” may be implemented by dedicated circuit, programmable circuit supplied along with a computer readable instruction stored on a computer readable storage medium, and/or a processor supplied along with the computer readable instruction stored on the computer readable storage medium. The dedicated circuit may include a digital and/or analog hardware circuit, or may include an integrated circuit (IC) and/or a discrete circuit. The programmable circuit may include, for example, a reconfigurable hardware circuit including logical AND, logical OR, logical XOR, logical NAND, logical NOR, and another logical operation, and a flip-flop, a register, and a memory element, such as a field programmable gate array (FPGA), a programmable logic array (PLA), or the like.

The computer readable storage medium may include any tangible device capable of storing an instruction executed by an appropriate device, so that the computer readable storage medium having the instruction stored thereon includes a product including an instruction that may be executed in order to provide means for executing an operation designated by a flowchart or a block diagram. Examples of the computer readable storage medium may include an electronic storage medium, a magnetic storage medium, an optical storage medium, an electromagnetic storage medium, a semiconductor storage medium, and the like. More specific examples of the computer readable storage medium may include a FLOPPY (registered trademark) disk, a diskette, a hard disk, a random access memory (RAM), a read only memory (ROM), an erasable programmable read only memory (EPROM or flash memory), an electrically erasable programmable read only memory (EEPROM), a static random access memory (SRAM), a compact disk read only memory (CD-ROM), a digital versatile disk (DVD), a BLU-RAY (registered trademark) disc, a memory stick, an integrated circuit card, or the like.

The computer readable instructions may include an assembler instruction, an instruction-set-architecture (ISA) instruction, a machine instruction, a machine dependent instruction, a microcode, a firmware instruction, state-setting data, or either of source code or object code described in any combination of one or more programming languages including an object oriented programming language such as SMALLTALK (registered trademark), JAVA (registered trademark), C++, or the like, and a conventional procedural programming language such as a “C” programming language or a similar programming language.

The computer readable instruction may be provided to a processor or a programmable circuit of a general-purpose computer, a special-purpose computer, or another programmable data processing apparatus locally or via a local area network (LAN), a wide area network (WAN) such as the Internet or the like in order that a processor or a programmable circuit of a programmable data processing apparatus such as a computer executes the computer readable instruction to generate means for executing operations designated by the flowchart or the block diagram. Here, the computer may be a computer such as a personal computer (PC), a tablet computer, smartphone, a work station, a server computer, a general-purpose computer, or a special-purpose computer, or may be a computer system in which a plurality of computers are connected. Such computer system in which the plurality of computers are connected is also referred to as a distributed computing system, and is a computer in a broad sense. In a distributed computing system, a plurality of computers collectively execute a program by each of the plurality of computers executing part of the program, and passing data during the execution of the program among the computers as needed.

Examples of the processor include a computer processor, a central processing unit, a processing unit, a microprocessor, a digital signal processor, a controller, a microcontroller, and the like. The computer may include one processor or a plurality of processors. In a multi-processor system including a plurality of processors, the plurality of processors collectively execute a program by each of the processors executing part of the program, and passing data during the execution of the program among the processors as needed. For example, in execution of multiple tasks, each of the plurality of processors may execute one portion of each task pieces by pieces by performing task-switching for each time slice. In this case, which portion of one program each processor is to execute dynamically changes. Which portion of the program each of the plurality of processors is to execute may be statically determined through multi-processor aware programming.

While the present invention has been described by way of the embodiments, the technical scope of the present invention is not limited to the above-described embodiments. It is apparent to persons skilled in the art that various alterations or improvements can be made to the above described embodiments. It is also apparent from the description of the claims that embodiments added with such alterations or improvements can be included in the technical scope of the present invention.

The operations, procedures, steps, stages, or the like of each process performed by a device, system, program, and method shown in the claims, embodiments, or diagrams can be performed in any order as long as the order is not indicated by “prior to,” “before,” or the like and as long as the output from a previous process is not used in a later process. Even if the process flow is described using phrases such as “first” or “next” in the claims, embodiments, or diagrams, it does not necessarily mean that the process must be performed in this order.

### EXPLANATION OF REFERENCES

10: information processing system, 50: network, 100: server, 110: domain divider, 200: model, 210: large model, 220: small model, 221: small general-purpose model, 2211: writing adapter, 2212: IT adapter, 2213: mathematic adapter, 222: small mathematic model, 230: tiny model, 231: tiny general-purpose model, 2311: writing adapter, 2312: IT adapter, 2313: mathematic adapter, 2314: finance adapter, 232: tiny mathematic model, 2321: linear algebra adapter, 240: general-purpose model, 242: adapter, 250: model for specific domain, 252: adapter, 300, 310, 320, 330, 340: communication terminal, 400, 410, 420, 430, 440: user, 502: model storage unit, 504: model provision unit, 506: information obtainment unit, 508: determination unit, 510: model adjustment unit, 512: learning execution unit, 600, 610, 620, 630, 640: optimizer, 1200: computer, 1210: host controller, 1212: CPU, 1214: RAM, 1216: graphics controller, 1218: display device, 1220: input/output controller, 1222: communication interface, 1224: storage apparatus, 1230: ROM, 1240: input/output chip.

What is claimed is:

1. An information processing system comprising:
a model provision unit which provides one or more models providing services to a user to a communication terminal of the user;
a determination unit which determines whether or not the one or more models provided to the communication terminal by the model provision unit are to be adjusted, based on a change in at least either an amount of free space in a storage area of the communication terminal or utilization-related information related to utilization of the communication terminal by the user; and
a model adjustment unit which adjusts the one or more models stored in the communication terminal, based on the amount of free space and the utilization-related information if the determination unit determines that the one or more models are to be adjusted.

2. The information processing system according to claim 1, wherein
the model provision unit prepares the one or more models to be provided to the communication terminal, by executing at least either selecting a model from a plurality of models or adjusting any of the plurality of models based on the amount of free space of the communication terminal and the utilization-related information.

3. The information processing system according to claim 1, wherein
the utilization-related information includes at least any of a purpose of utilization of the communication terminal by the user, a history of the utilization of the communication terminal by the user, or a preference, specified based on the utilization of the communication terminal by the user, of the user.

4. The information processing system according to claim 1, wherein
the determination unit determines that the one or more models provided to the communication terminal by the model provision unit are to be adjusted, if an amount of the change in at least either the amount of free space or the utilization-related information is greater than a predetermined threshold value.

5. The information processing system according to claim 4, wherein
the model adjustment unit executes at least any of erasing any of the one or more models stored in the communication terminal, reducing a function of at least any model of the one or more models to reduce an amount of data, or subdividing at least any model of the one or more models to erase some of models obtained through subdivision, based on the utilization-related information such that a total amount of data of the one or more models stored in the communication terminal is reduced if the amount of free space is reduced.

6. The information processing system according to claim 4, wherein
the model adjustment unit executes at least any of adding one or more models, increasing a function of at least any model of the one or more models stored in the communication terminal to increase an amount of data, or replacing at least any model of the one or more models with a higher-level model, based on the utilization-related information such that a total amount of data of the one or more models stored in the communication terminal is increased if the amount of free space is increased.

7. The information processing system according to claim 4, wherein
the model adjustment unit executes at least either adjusting at least any of the one or more models stored in the communication terminal or erasing at least any of the one or more models stored in the communication terminal, such that the one or more models stored in the communication terminal are more adapted to the utilization-related information which has been changed, if an amount of a change in the utilization-related information is greater than a predetermined threshold value.

8. The information processing system according to claim 1, wherein
the determination unit determines whether or not the one or more models provided to the communication terminal by the model provision unit are to be adjusted, based on a change in a position of the communication terminal, and
the model adjustment unit adjusts the one or more models stored in the communication terminal, based on the position of the communication terminal if the determination unit determines that the one or more models are to be adjusted.

9. The information processing system according to claim 1, wherein
the determination unit determines whether or not the one or more models provided to the communication terminal by the model provision unit are to be adjusted, based on a change in a situation of the user, and
the model adjustment unit adjusts the one or more models stored in the communication terminal, based on the change in the situation of the user if the determination unit determines that the one or more models are to be adjusted.

10. The information processing system according to claim 1, comprising:
a domain divider having: the one or more models; the model provision unit; and the model adjustment unit; and
an optimizer having the determination unit.

11. An information processing method executed by an information processing system, the information processing method comprising:
providing one or more models providing services to a user to a communication terminal of the user;
determining whether or not the one or more models provided to the communication terminal in the providing the one or more models are to be adjusted, based on a change in at least either an amount of free space in a storage area of the communication terminal or utilization-related information related to utilization of the communication terminal by the user; and
adjusting the one or more models stored in the communication terminal, based on the amount of free space and the utilization-related information if it is determined in the determining that the one or more models are to be adjusted.

12. A non-transitory computer readable storage medium having stored thereon a program which causes a computer to execute operations including:
providing one or more models providing services to a user to a communication terminal of the user;
determining whether or not the one or more models provided to the communication terminal in the providing the one or more models are to be adjusted, based on a change in at least either an amount of free space in a storage area of the communication terminal or utilization-related information related to utilization of the communication terminal by the user; and
adjusting the one or more models stored in the communication terminal, based on the amount of free space and the utilization-related information if it is determined in the determining that the one or more models are to be adjusted.
